(19) United States
(12) Patent Application Publication
(10) Pub. No.: US 2025/0091871 A1
(43) Pub. Date: Mar. 20, 2025

(54) METHOD FOR RECYCLING LITHIUM-ION BATTERY ELECTROLYTE

(71) Applicants: GUANGDONG BRUNP RECYCLING TECHNOLOGY CO., LTD., Foshan, Guangdong (CN); HUNAN BRUNP RECYCLING TECHNOLOGY CO., LTD., Changsha, Hunan (CN); HUNAN BRUNP EV RECYCLING CO., LTD., Changsha, Hunan (CN)

(72) Inventors: Haijun Yu, Foshan, Guangdong (CN); Yinghao Xie, Foshan, Guangdong (CN); Aixia Li, Foshan, Guangdong (CN); Xuemei Zhang, Foshan, Guangdong (CN); Changdong Li, Foshan, Guangdong (CN)

(21) Appl. No.: 18/728,899

(22) PCT Filed: Dec. 1, 2022
(86) PCT No.: PCT/CN2022/135992

§ 371 Date: Jul. 15, 2024

(30) Foreign Application Priority Data
Feb. 18, 2022 (CN) 202210150550.6

(51) Int. Cl. C01B 25/455; H01M 10/54

(52) U.S. Cl. CPC C01B 25/455; H01M 10/54

(57) ABSTRACT

The present disclosure discloses a method for recycling a lithium-ion battery electrolyte. After the waste lithium-ion battery is discharged, it is frozen and disassembled to obtain a battery cell containing an electrolyte. The battery cell is immersed in a lithium hydroxide solution containing a catalyst for reaction. The battery cell after the reaction is taken out and washed. The washing solution is mixed with the lithium hydroxide solution after the reaction to obtain a mixed solution. The mixed solution is filtered to obtain a filtrate and a filter residue. The filter residue is reacted with a hydrofluoric acid solution to obtain anhydrous lithium salt. The anhydrous lithium salt is mixed with an organic solution, and PF₅ gas is introduced. The mixture is reacted, and filtered to obtain an organic liquid. The organic solution is frozen and filtered to obtain lithium hexafluorophosphate.

### FIELD

The present application relates to the technical field of battery recycling, and in particular to a method for recycling a lithium-ion battery electrolyte.

### BACKGROUND

At present, LiCoO₂, LiNiO₂, LiMn₂O₄, LiFePO₄ and a ternary material are commonly used as a cathode material for a lithium-ion battery. The cathode material, acetylene black conductive agent and organic binder are coated on aluminum foil to form the cathode, and a sheet carbon material and an amorphous carbon material are coated on copper foil to form the anode. The electrolyte salts in the electrolyte solution are generally lithium salts such as LiPF₆, LiCF₃SO₃ and LiBF₄, and the commonly used solvents are ethylene carbonate (EC), propylene carbonate (PC), dimethyl carbonate (DMC), and ethyl methyl carbonate (EMC), etc.

The output of the lithium-ion battery in China maintains a strong growth trend, and the lithium-ion battery that is scrapped beyond its service life will increase year by year. The scrapped lithium-ion battery contains not only cobalt, which is of great recycling value, but also metals such as iron, aluminum, and copper, as well as organic electrolytes, which have potential economic value and great risk for pollution. Recycling and disposing of the wasted lithium-ion battery can not only eliminate the source of pollution, but also realize the recycling and reuse of resources.

The recycling technology of the lithium-ion battery can be divided into pyrometallurgy method, hydrometallurgy method and biological method. In the treatment processes of pyrometallurgy and hydrometallurgy, most of the processes do not consider recycling electrolyte, which brings great safety hazards to production and also produces relatively serious environmental pollution. During the pyrometallurgy treatment, an organic solvent in the electrolyte will be volatilized or combusted to be decomposed into water vapor and CO₂ to be discharged, while LiPF₆ will be rapidly decomposed into gas PF₅ when heated in the air, and finally form fluorine-containing flue gas and smoke dust to be discharged to the outside. During the hydrometallurgy treatment of the waste battery, taking the decomposition of lithium salt LiPF₆ in the electrolyte as an example, it is very easy for HF and PF₅ to form soluble fluorides, causing fluorine pollution in water. The transformation and migration of fluorine-containing waste gas and waste water in the environment directly or indirectly endanger human health. In addition, the biological method, namely microbial leaching method, can also be used to treat the waste lithium battery. Microorganisms can be used to convert useful components of the system into soluble compounds and selectively dissolve them out to obtain metal-containing solutions, to achieve the separation of target components from impurity components, and finally recycle useful metals. Specifically, a metabolic process of the microorganisms, fungi is mainly used to achieve selective leaching of cobalt, lithium and other metal elements, but it is impossible to effectively recycle and dispose of the electrolyte at the same time.

At present, the research on the recycling of the waste lithium-ion battery mainly focuses on the electrode materials with higher value containing non-ferrous metals such as cobalt, lithium, nickel, and copper. Additionally, the electrolyte is volatile and difficult to be recycled, so few researches and treatments are devoted to the recycle of the electrolyte. However, the volatilization of the electrolyte will produce an unpleasant and irritating odor, and the hydrolysis of the lithium salt in the electrolyte will produce toxic arsenide, phosphide and fluoride, which are very harmful to the human body and the environment. This has become an unavoidable problem. On the one hand, the electrolyte accounts for about 12% of the total cost of the battery. However, due to the insufficient production capacity of the electrolyte at the current stage and the monopoly of the production technology of high-purity lithium salts by foreign companies, recycling the electrolyte for reuse has higher economic value. On the other hand, since the electrolyte itself is toxic to the environment and human body, the electrolyte must be effectively treated from the perspective of safety and environmental protection.

### SUMMARY

The following is a summary of subject matters described in detail herein. This summary is not intended to limit the scope of protection of claims.

In order to overcome the problem that the lithium-ion battery electrolyte cannot be recycled in an environmentally friendly and efficient manner existing in the related art, an embodiment of the present application provides a method for recycling the lithium-ion battery electrolyte.

A method for recycling a lithium-ion battery electrolyte includes the following steps:
(1) freezing a waste lithium-ion battery after being discharged; disassembling the frozen waste lithium-ion battery to obtain a battery cell containing an electrolyte;
(2) immersing the battery cell obtained in step (1) in a lithium hydroxide solution containing a catalyst for reaction;
(3) taking out the battery cell after the reaction in step (2), and washing the battery cell with a lithium hydroxide solution to obtain a washing solution; mixing the washing solution with the lithium hydroxide solution after the reaction in step (2) to obtain a mixed solution;
(4) filtering the mixed solution obtained in step (3) to obtain a filtrate and a filter residue;
(5) mixing the filter residue obtained in step (4) with a hydrofluoric acid solution, heating and evaporating to dryness, and then calcining to obtain anhydrous lithium salt;
(6) mixing the anhydrous lithium salt obtained in step (5) with an organic solvent, introducing gas PF₅, reacting, and filtering to obtain an organic liquid; and
(7) freezing and filtering the organic liquid obtained in step (6) to obtain lithium hexafluorophosphate.

Preferably, in the method for recycling the lithium-ion battery electrolyte, in step (1), the components of the electrolyte include at least one of ethylene carbonate, propylene carbonate, dimethyl carbonate, and ethyl methyl carbonate.

The disassembled battery cell is placed in the lithium hydroxide solution containing the catalyst. On the one hand, the solvent (such as dimethyl carbonate) in the electrolyte is decomposed into alcohols and carbon dioxide under the action of the catalyst, and the carbon dioxide reacts with lithium hydroxide to generate lithium carbonate precipitate; on the other hand, the solute lithium hexafluorophosphate in the electrolyte reacts with lithium hydroxide, with the equation as follows:

LiPF₆+14LiOH=6LiOH·LiF↓Li₃PO₄↓4H₂O

Through the reaction of the precipitate with hydrofluoric acid, hydroxide radical and carbonate radical in the precipitate are removed, and the following reactions occur:

LiOH+HF=LiF+H₂O

Li₂CO₃+2HF=2LiF+H₂O+CO₂

LiF+HF=LiHF₂

Further through calcination, LiHF₂ is decomposed into lithium fluoride and hydrogen fluoride, thereby obtaining the anhydrous lithium salt with only lithium fluoride and lithium phosphate; and then the anhydrous lithium salt is reacted with phosphorus pentafluoride in an organic solvent to obtain recovered lithium phosphate, with the process as follows, taking acetonitrile as an example:

LiF+PF₅+4CH₃CN→Li(CH₃CN)₄PF₆→LiPF₆

Preferably, in the method for recycling the lithium-ion battery electrolyte, in step (1), the freezing temperature is no more than −50° C.; further preferably, the freezing temperature is no more than −55° C.; and still further preferably, the freezing temperature is no more than −60° C.

Preferably, in the method for recycling the lithium-ion battery electrolyte, in step (2), the catalyst includes at least one of quaternary ammonium salt and methylamino diethanol; further preferably, the quaternary ammonium salt is chloride salt or bromide salt, the total number of carbon atoms on the hydrocarbon group is <12; in some preferred embodiments of the present application, the catalyst is at least one of [(CH₃)₃NCH₂CH₂Cl]Cl or [(CH₃CH₂)₃NCH₂CH₂OH]Cl.

Preferably, in the method for recycling the lithium-ion battery electrolyte, in step (2), the concentration of the catalyst is 5 g/L to 60 g/L; further preferably, the concentration of the catalyst is 8 g/L to 55 g/L; and still further preferably, the concentration of the catalyst is 10 g/L to 50 g/L.

Preferably, in the method for recycling the lithium-ion battery electrolyte, in step (2), the concentration of the lithium hydroxide is 0.1 mol/L to 4 mol/L.

Preferably, in the method for recycling the lithium-ion battery electrolyte, in step (2), the reaction time is 0.3 h to 3 h; further preferably, the reaction time is 0.4 h to 2.5 h; and still further preferably, the reaction time is 0.5 h to 2 h.

Preferably, in the method for recycling the lithium-ion battery electrolyte, in step (2), the amount of the liquid solution is enough to cover the battery cell.

Preferably, in the method for recycling the lithium-ion battery electrolyte, in step (3), the concentration of the lithium hydroxide solution is 0.1 mol/L to 4 mol/L.

Preferably, in the method for recycling the lithium-ion battery electrolyte, in step (5), the hydrogen fluoride is recycled by heating and evaporation to dryness; and further preferably, the hydrogen fluoride is recycled by heating at a temperature of 50° C. to 70° C.

Preferably, in the method for recycling the lithium-ion battery electrolyte, in step (5), the calcination temperature is 500° C. to 800° C.; further preferably, the calcination temperature is 550° C. to 750° C.; and still further preferably, the calcination temperature is 600° C. to 700° C.

Preferably, in the method for recycling the lithium-ion battery electrolyte, in step (5), the calcination time is 0.3 h to 3 h; further preferably, the calcination time is 0.4 h to 2.5 h; still further preferably, the calcination time is 0.5 h to 2 h.

Preferably, in the method for recycling the lithium-ion battery electrolyte, in step (6), the organic solvent includes at least one of acetonitrile, diethyl ether, pyrrole, and pyridine; further preferably, the organic solvent includes one of acetonitrile, diethyl ether, and pyrrole; still further preferably, the organic solvent is one of acetonitrile and diethyl ether.

Preferably, in the method for recycling the lithium-ion battery electrolyte, in step (6), the liquid-solid ratio of the organic solvent to the anhydrous lithium salt is (30 to 60) mL:1 g; further preferably, the liquid-solid ratio of the organic solvent to the anhydrous lithium salt is (35 to 55) mL:1 g; still further preferably, the liquid-solid ratio of the organic solvent to the anhydrous lithium salt is (40 to 50) mL:1 g.

Preferably, in the method for recycling the lithium-ion battery electrolyte, in step (6), the reaction pressure is 0.2 MPa to 0.8 MPa; further preferably, the reaction pressure is 0.25 MPa to 0.75 MPa; still further preferably, the reaction pressure is 0.3 MPa to 0.7 MPa.

Preferably, in the method for recycling the lithium-ion battery electrolyte, in step (6), the reaction time is 0.5 h to 3 h; further preferably, the reaction time is 0.8 h to 2.5 h; still further preferably, the reaction time is 1 h to 2 h.

Preferably, in the method for recycling the lithium-ion battery electrolyte, in step (6), the temperature during filtration is 40° C. to 80° C.; further preferably, the temperature during filtration is 45° C. to 75° C.; still further preferably, the temperature during filtration is 50° C. to 70° C.

Preferably, in the method for recycling the lithium-ion battery electrolyte, in step (7), the freezing temperature is −40° C. to −10° C.; further preferably, the freezing temperature is −35° C. to −15° C.; and still further preferably, the freezing temperature is −30° C. to −20° C.

Preferably, in step (7), the method for recycling the lithium-ion battery electrolyte further includes a step of drying the filter cake obtained by filtration, and the drying is performed under a nitrogen atmosphere; further preferably, the drying temperature is 0° C. to 8° C., and the drying time is 10 h to 26 h; still further preferably, the drying temperature is 0° C. to 5° C., and the drying time is 12 h to 24 h.

The present application has the following beneficial effects.
1. According to the present application, the waste lithium-ion battery is frozen and then disassembled to avoid the volatilization and decomposition of the electrolyte to pollute the environment; the lithium hexafluorophosphate prepared according to the method of the present application has high purity and meets the standard requirement of “HG/T 4066-2015 Lithium Hexafluorophosphate Electrolyte”.
2. Since the electrolyte of the waste battery has been used for a long time, there are many impurities inside, and it is difficult to continue to reuse the electrolyte. Especially, the side reactions of various esters are carried out in the solvent, therefor, the solvent cannot be reused basically. In the present application, by means of catalytic decomposition, the electrolyte generates alcohols and carbon dioxide that are easily soluble in water, so as to avoid aggregation and fire caused by the insolubility of the electrolyte and water, and further promote the reaction under the action of lithium hydroxide. Both fluorine and lithium in the solute lithium hexafluorophosphate in the electrolyte have higher economic value. Lithium hydroxide is used to precipitate lithium hexafluorophosphate, and then a series of reactions are performed to obtain recovered lithium hexafluorophosphate. The whole process only consumes lithium hydroxide and the recycling cost is low.
3. Using the method that lithium phosphate is insoluble in organic solvent, lithium hexafluorophosphate is generated by lithium fluoride and phosphorus pentafluoride, and then lithium phosphate is separated to obtain pure lithium hexafluorophosphate.

Other aspects can be understood upon reading and understanding the drawings and detailed descriptions.

### BRIEF DESCRIPTION OF THE DRAWINGS

The drawings are used to provide a further understanding of the technical solutions herein and constitute part of the description, and are used together with the examples of the present application to interpret the technical solution herein, and do not constitute a limitation on the technical solution herein

FIG. 1 is a schematic diagram of a method for recycling a lithium-ion battery electrolyte according to an example.

### DETAILED DESCRIPTION

The content of the present application will be further described in detail below through specific examples. Unless otherwise specified, the raw materials or devices used in the examples can be obtained from conventional commercial channels, or can be obtained by methods of the related art. Unless otherwise specified, test or test methods are routine in the art.

### Example 1

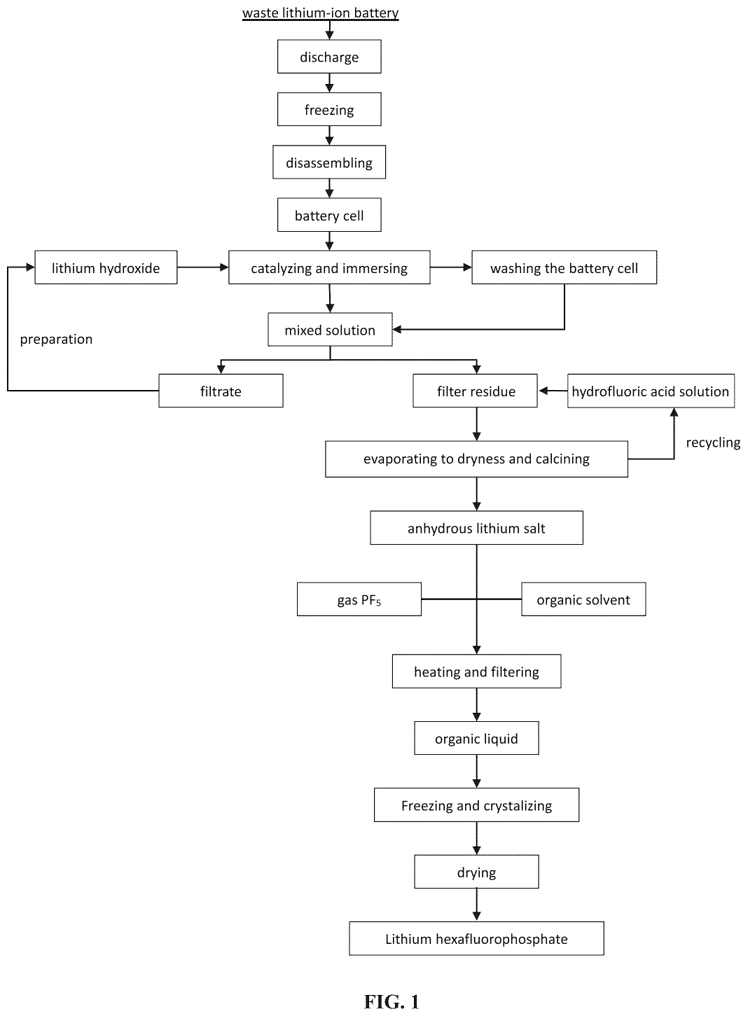

Referring to the schematic diagram of FIG. 1, the method for recycling a lithium-ion battery electrolyte in the present example included the following steps:
(1) after the waste lithium-ion battery was discharged, it was frozen to −60° C. or less by using liquid nitrogen;
(2) the frozen waste lithium-ion battery was disassembled, and a battery cell containing an electrolyte was taken out;
(3) the battery cell was immersed in a lithium hydroxide solution containing a catalyst for 2 h, the battery cell was all covered by the liquid, the concentration of the lithium hydroxide solution was 0.1 mol/L, the catalyst was methylamino diethanol, and the concentration thereof was 10 g/L;
(4) the battery cell obtained after the reaction in step (3) was taken out, and washed with a lithium hydroxide solution with a concentration of 0.1 mol/L to obtain a washing solution; the washing solution was mixed with the lithium hydroxide solution obtained after the reaction in step (3) to obtain a mixed solution;
(5) the mixed solution was filtered to obtain filtrate and filter residue;
(6) the filter residue was added to a sufficient amount of hydrofluoric acid solution, and then the mixture was heated and evaporated to dryness to recycle redundant hydrogen fluoride, and was calcined at a temperature of 600° C. for 2 h to obtain anhydrous lithium salt;
(7) according to the liquid-solid ratio of 40 mL:1 g, anhydrous lithium salt was added into anhydrous acetonitrile, and the mixture was put in a closed environment, in which gas PF₅ was slowly introduced, so that the reaction system pressure was 0.3 MPa, to react for 2 h. After the reaction was completed, the mixture was heated to 50° C. and filtered to obtain an organic liquid;
(8) the organic liquid was frozen to −30° C. to separate out crystal, and filtered to obtain a filter cake; and
(9) the filter cake was dried at 0° C. for 24 h under nitrogen atmosphere to obtain lithium hexafluorophosphate.

The prepared lithium hexafluorophosphate met the standard requirement of “HG/T 4066-2015 Lithium Hexafluorophosphate Electrolyte”.

### Example 2

Referring to the schematic diagram of FIG. 1, the method for recycling a lithium-ion battery electrolyte in the present example included the following steps:
(1) after the waste lithium-ion battery was discharged, it was frozen to −60° C. or less by using liquid nitrogen;
(2) the frozen waste lithium-ion battery was disassembled, and a battery cell containing an electrolyte was taken out;
(3) the battery cell was immersed in a lithium hydroxide solution containing a catalyst for 1 h, the battery cell was all covered by the liquid, the concentration of the lithium hydroxide solution was 2 mol/L, the catalyst was [(CH₃)₃NCH₂CH₂Cl]Cl, and the concentration thereof was 30 g/L;
(4) the battery cell obtained after the reaction in step (3) was taken out, and washed with a lithium hydroxide solution with a concentration of 2 mol/L to obtain a washing solution; the washing solution was mixed with the lithium hydroxide solution obtained after the reaction in step (3) to obtain a mixed solution;
(5) the mixed solution was filtered to obtain filtrate and filter residue;
(6) the filter residue was added to a sufficient amount of hydrofluoric acid solution, and then the mixture was heated and evaporated to dryness to recycle redundant hydrogen fluoride, and was calcined at a temperature of 650° C. for 1 h to obtain anhydrous lithium salt;
(7) according to the liquid-solid ratio of 45 mL:1 g, anhydrous lithium salt was added into anhydrous acetonitrile, and the mixture was put in a closed environment, in which gas PF₅ was slowly introduced, so that the reaction system pressure was 0.5 MPa, to react for 1.5 h. After the reaction was completed, the mixture was heated to 60° C. and filtered to obtain an organic liquid;
(8) the organic liquid was frozen to −25° C. to separate out crystal, and filtered to obtain a filter cake; and
(9) the filter cake was dried at 3° C. for 18 h under nitrogen atmosphere to obtain lithium hexafluorophosphate.

The prepared lithium hexafluorophosphate met the standard requirement of “HG/T 4066-2015 Lithium Hexafluorophosphate Electrolyte”.

### Example 3

Referring to the schematic diagram of FIG. 1, the method for recycling a lithium-ion battery electrolyte in the present example included the following steps:
(1) after the waste lithium-ion battery was discharged, it was frozen to −60° C. or less by using liquid nitrogen;
(2) the frozen waste lithium-ion battery was disassembled, and a battery cell containing an electrolyte was taken out;
(3) the battery cell was immersed in a lithium hydroxide solution containing a catalyst for 0.5 h, the battery cell was all covered by the liquid, the concentration of the lithium hydroxide solution was 4 mol/L, the catalyst was [(CH₃CH₂)₃NCH₂CH₂OH]Cl, and the concentration thereof was 50 g/L;
(4) the battery cell obtained after the reaction in step (3) was taken out, and washed with a lithium hydroxide solution with a concentration of 4 mol/L to obtain a washing solution; the washing solution was mixed with the lithium hydroxide solution obtained after the reaction in step (3) to obtain a mixed solution;
(5) the mixed solution was filtered to obtain filtrate and filter residue;
(6) the filter residue was added to a sufficient amount of hydrofluoric acid solution, and then the mixture was heated and evaporated to dryness to recycle redundant hydrogen fluoride, and was calcined at a temperature of 700° C. for 0.5 h to obtain anhydrous lithium salt;
(7) according to the liquid-solid ratio of 50 mL:1 g, anhydrous lithium salt was added into anhydrous diethyl ether, and the mixture was put in a closed environment, in which gas PF₅ was slowly introduced, so that the reaction system pressure was 0.7 MPa, to react for 1 h. After the reaction was completed, the mixture was heated to 70° C. and filtered to obtain an organic liquid;
(8) the organic liquid was frozen to −20° C. to separate out crystal, and filtered to obtain a filter cake; and
(9) the filter cake was dried at 5° C. for 24 h under nitrogen atmosphere to obtain lithium hexafluorophosphate.

The prepared lithium hexafluorophosphate met the standard requirement of “HG/T 4066-2015 Lithium Hexafluorophosphate Electrolyte”.

1. A method for recycling a lithium-ion battery electrolyte, comprising the following steps:
(1) freezing a waste lithium-ion battery after being discharged; disassembling the frozen waste lithium-ion battery to obtain a battery cell containing an electrolyte;
(2) immersing the battery cell obtained in step (1) in a lithium hydroxide solution containing a catalyst for reaction;
(3) taking out the battery cell after the reaction in step (2), and washing the battery cell with a lithium hydroxide solution to obtain a washing solution; mixing the washing solution with the lithium hydroxide solution after the reaction in step (2) to obtain a mixed solution;
(4) filtering the mixed solution obtained in step (3) to obtain a filtrate and a filter residue;
(5) mixing the filter residue obtained in step (4) with a hydrofluoric acid solution, heating and evaporating to dryness, and then calcining to obtain an anhydrous lithium salt;
(6) mixing the anhydrous lithium salt obtained in step (5) with an organic solvent, introducing gas PF₅, reacting, and filtering to obtain an organic liquid; and
(7) freezing and filtering the organic liquid obtained in step (6) to obtain lithium hexafluorophosphate.

2. The method for recycling the lithium-ion battery electrolyte according to claim 1, wherein in step (1), components of the electrolyte comprise at least one of ethylene carbonate, propylene carbonate, dimethyl carbonate, and ethyl methyl carbonate.

3. The method for recycling the lithium-ion battery electrolyte according to claim 1, wherein in step (2), the catalyst comprises at least one of quaternary ammonium salt and methylamino diethanol.

4. The method for recycling the lithium-ion battery electrolyte according to claim 1, wherein in step (2), a reaction time is 0.3 h to 3 h.

5. The method for recycling the lithium-ion battery electrolyte according to claim 1, wherein in step (5), a calcination temperature is 500° C. to 800° C.; and a calcination time is 0.3 h to 3 h.

6. The method for recycling the lithium-ion battery electrolyte according to claim 1, wherein in step (6), the organic solvent comprises at least one of acetonitrile, diethyl ether, pyrrole, and pyridine.

7. The method for recycling the lithium-ion battery electrolyte according to claim 1, wherein in step (6), a liquid-solid ratio of the organic solvent to the anhydrous lithium salt is (30 to 60) mL:1 g.

8. The method for recycling the lithium-ion battery electrolyte according to claim 1, wherein in step (6), a reaction pressure is 0.2 MPa to 0.8 MPa; and a reaction time is 0.5 h to 3 h.

9. The method for recycling the lithium-ion battery electrolyte according to claim 1, wherein in step (6), a temperature during the filtration is 40° C. to 80° C.

10. The method for recycling the lithium-ion battery electrolyte according to claim 1, wherein in step (7), a freezing temperature is −40° C. to −10° C.
